(19) United States
(12) Patent Application Publication
(10) Pub. No.: US 2026/0314770 A1
(43) Pub. Date: Oct. 15, 2026

(54) Floating Decoy Bag

(71) Applicant: Good Sportsman Marketing, LLC, Irving, TX (US)

(72) Inventor: Fred L. Zink, JR., Port Clinton, OH (US)

(21) Appl. No.: 19/640,205

(22) Filed: Apr. 6, 2026

Related U.S. Application Data
(60) Provisional application No. 63/786,125, filed on Apr. 9, 2025.

(51) Int. Cl. A45C 3/00; A01M 31/06; A45C 13/02; A45C 13/10; A45C 13/26; A45F 3/04

(52) U.S. Cl. CPC A45C 3/001; A01M 31/06; A45C 13/103; A45C 13/26; A45F 3/04; A45C 2003/002; A45C 2003/007; A45C 2013/026

(57) ABSTRACT

A bag is used to store and haul waterfowl decoys used in water. The bag includes a sidewall and a bottom, which enclose an interior for storage of the waterfowl decoys. The interior is divided into a plurality of pockets by dividers, and at least a portion of the sidewall defines a vent exposing the interior outside the bag. A flap attached to an edge of the sidewall is movable between opened and closed positions over the interior. The dividers in the interior can have handles attached, and the flap can have an opening for passage of handles through the flap when closed. A sleeve disposed at the bottom of the bag has a receptacle in which a float is disposed. The float is buoyant and supports the bag on the water surface.

### CROSS-REFERENCE TO RELATED APPLICATIONS

This application claims the benefit of U.S. Provisional Appl. No. 63/786,125 filed Apr. 9, 2025, which is incorporated herein by reference in its entirety.

### BACKGROUND OF THE DISCLOSURE

Decoys for waterfowl can be used to create the illusion of a safe, attractive gathering spot where the waterfowl can land, feed, or rest. For example, ducks are social birds and tend to flock toward other ducks when migrating or looking for safe places to land. When ducks see what looks like a group already on the water, the ducks are more likely to come in range of the hunters, believing it is a safe and active spot.

The use of decoys for waterfowl, such as ducks, is thousands of years old and is one of the oldest hunting tools in North America. Earliest decoys dating back over 2,000 years were made by Native American tribes (like the Paiute) and have been found in caves around present-day Nevada. These decoys used bulrushes and feathers. In the 1800s and early 1900s, hunters made hand-carved, hand-painted wooden decoys, and decoy carving became an American folk art.

In use, the decoys are arranged in a spread to float on the water, and anchor rigs anchor the decoys. Hunters strategically place the spread of multiple decoys on the water in a realistic pattern that mimics the behavior of live ducks. Hunters use patterns, numbers, and positioning in the spread based on duck behavior, weather, and location. The decoys can be stationary or motion-based (like spinning wing decoys) to add movement and make the setup more convincing.

Hunters may use species-specific decoys (mallards, pintails, teal) to match local flocks. Early in the season, hunters may use smaller spreads of decoys but may use much larger spreads of decoys late in the season when ducks are flocking heavily. Different spread patterns can be used. In J-Hook or Fishhook patterns, for example, ducks tend to land at the open end of the hook. In U-Shape or Horseshoe patterns, ducks naturally land in the opening. Ducks prefer to land into the wind so hunters will often leave an open pocket upwind, steering the ducks toward that area. Additionally, the decoys are usually spaced with enough room between them to look realistic.

Hunters have to transport, set up, and take down the multiple decoys. When a conventional bag is used to hold the decoys, the bag can fill with water, making the bag very heavy and cumbersome. When the bag is full of decoys, the bag will also tend to sink below the water surface. For this reason, hunters tend to use small boats or jet sleds to haul their decoys in such settings. With all the gear that hunters use, the need to also haul small boats or sleds to a hunting location takes up available space and adds additional weight to transport.

The subject matter of the present disclosure is directed to overcoming, or at least reducing the effects of, one or more of the problems set forth above.

### SUMMARY OF THE DISCLOSURE

As disclosed herein, a bag for waterfowl decoys can be used in water. The bag comprises a body and a float. The body at least forms a sidewall and a bottom of the bag and encloses an interior for storage of the waterfowl decoys. At least a portion of the body, such as the sidewall, defines a vent exposing the interior outside the bag. The float is disposed on the bag. The float is buoyant and is configured to support the bag on the water surface. The bag can comprise a tow line attached toward the bottom.

The interior can be divided into a plurality of pockets by dividers. These dividers can be removable from the interior. Alternatively, the dividers can be affixed in the interior to at least one of the sidewall and the bottom.

The float can comprise one of: a closed-cell foam, an inflatable bladder, and a sealed container. The float can be disposed at the bottom of the bag. For example, the bottom of the bag can comprise a sleeve having a pocket in which the float is disposed. This sleeve can be integral to the bottom of the bag, or the sleeve can be removably affixable to the bottom. The pocket of the sleeve can have an opening through which the float is removably inserted.

The body of the bag can also comprise a flap being movable between opened and closed positions over the interior. A fastener arrangement can be configured to releasable fasten the flap closed. The interior can be divided into a plurality of pockets by dividers, and these dividers can be affixed in the interior and can have handles attached thereto. The flap can define an opening for passage of the handles through the flap in the closed position.

In one arrangement, for example, a bag for waterfowl decoys can be used in water comprises a body and a float. The body at least forms a sidewall, a bottom, and a flap of the bag, and the body encloses an interior for storage of the waterfowl decoys. The interior is divided into a plurality of pockets by dividers. The dividers are affixed in the interior and have handles attached thereto. At least a portion of the body (such as the sidewall) defines a vent exposing the interior outside the bag. The flap is movable between opened and closed positions over the interior. The flap defines an opening for passage of the handles through the flap in the closed position.

In another arrangement, for example, a bag for waterfowl decoys can be used in water comprises a body, a fastener arrangement, and a float. The body at least forms a sidewall, a bottom, and a top of the bag, and the body encloses an interior for storage of the waterfowl decoys. The top defines an opening exposed to the interior, and at least a portion of the body (i.e., sidewalls) defines a vent exposing the interior outside the bag. The fastener arrangement disposed on the body is configured to open and close the opening in the top of the body.

In either of the above arrangements, the float disposed on the bag is buoyant and is configured to support the bag on the water surface. A sleeve can be disposed at the bottom of the bag and can have a receptacle for the sleeve. Again, the sleeve can be integral to the bottom or can be removably affixable to the bottom. The receptacle of the sleeve can have an opening through which the float is removably inserted. At least a portion of the sleeve can define another vent exposing the receptacle outside the bag.

A fastener arrangement can be configured to releasable fasten the flap closed, and a tow line can be attached toward the bottom. Additionally, the float can comprise one of: a closed-cell foam, an inflatable bladder, and a sealed plastic container.

The foregoing summary is not intended to summarize each potential embodiment or every aspect of the present disclosure.

### BRIEF DESCRIPTION OF DRAWINGS

FIG. 1A illustrates a side view of a floating decoy bag according to the present disclosure.

FIG. 1B illustrates a top view of the floating decoy bag.

FIG. 1C illustrates a bottom view of the floating decoy bag.

FIG. 1D illustrates a side view of the floating decoy bag having a decoy stored in a pocket.

FIGS. 2A-2B illustrates side views of another floating decoy bag according to the present disclosure.

FIG. 3A illustrates a side view of yet another floating decoy bag according to the present disclosure.

FIG. 3B illustrates a perspective view of the floating decoy bag.

FIG. 3C illustrates a bottom view of the floating decoy bag.

FIG. 3D illustrates a top view of the floating decoy bag with the flap closed.

FIG. 3E illustrates a top view of the floating decoy bag with the flap open.

FIG. 4 illustrates the view of the floating decoy bag in FIG. 3B including shoulder straps.

FIGS. 5A-5C illustrates various views of another floating decoy bag of the present disclosure.

FIG. 6A illustrates the floating decoy bag being moved along the surface of the water by a hunter.

FIG. 6B illustrates the floating decoy bag open on the surface of the water.

FIGS. 7A-7C illustrates various views of yet another floating decoy bag of the present disclosure.

FIG. 8 illustrates an alternative floating decoy bag of the present disclosure.

FIG. 9 illustrates yet another alternative floating decoy bag of the present disclosure.

### DETAILED DESCRIPTION OF THE DISCLOSURE

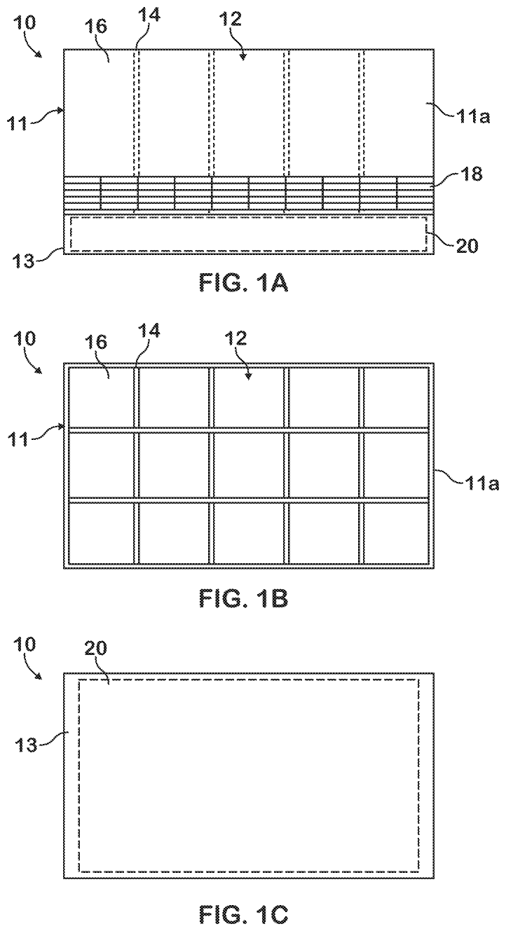

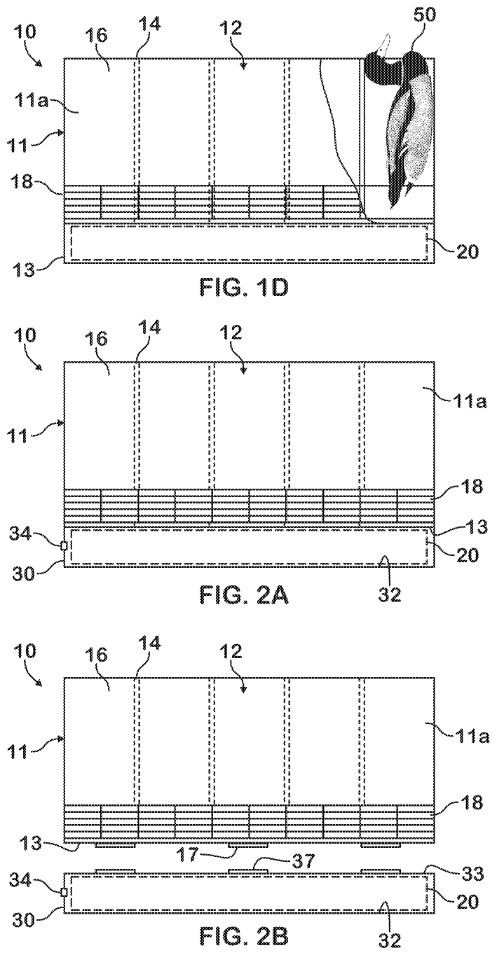

FIGS. 1A, 1B, and 1C illustrate side, top, and bottom views of a floating decoy bag 10 according to the present disclosure. FIG. 1D illustrates a side view of the floating decoy bag 10 with its interior partially exposed. The bag 10 is used for holding waterfowl decoys. The bag 10 includes a body 11 forming a sidewall 11a and a bottom 13, which enclose an interior 12 for storage of the waterfowl decoys (not shown). The sidewall 11a encircles the interior 12, making up four sides of the bag 10. The bottom 13 covers the bottom of the interior 12. At least a portion of the sidewall 11a defines a vent 18 exposing the interior 12 outside the bag 10 so any water caught in the interior 12 can escape.

As shown, the interior 12 can be divided into a plurality of pockets 16 by dividers 14 so individual decoys 50 as shown in FIG. 1D can be stored in each pocket 16. The dividers 14 can be removable from the interior 12, or the dividers 14 can be affixed to the sidewall 11a and the bottom 13. As shown in FIGS. 1A-1C, a float 20 is disposed on the bag 10. The float 20 is buoyant and supports the bag 10 on the water surface. To support the majority of the bag 10 above the water surface, to make towing the bag 10 easier along the water surface, and to allow most water to escape from the interior 12, the float 20 is disposed at the bottom 13 of the bag 10. Although not shown, the bag 10 can include handles and/or a shoulder strap and can include a cover or flap.

For the bag 10 in FIGS. 1A-1D, the float 20 can be integral to the bottom 13 of the bag 10. The float 20, which may be made of a closed-cell foam or the like can be attached directly to the bottom 13 of the bag 10, or the float 20 can be encased in (and protected by) fabric material integral with the body 11 (i.e., the sidewall 11a and bottom 13).

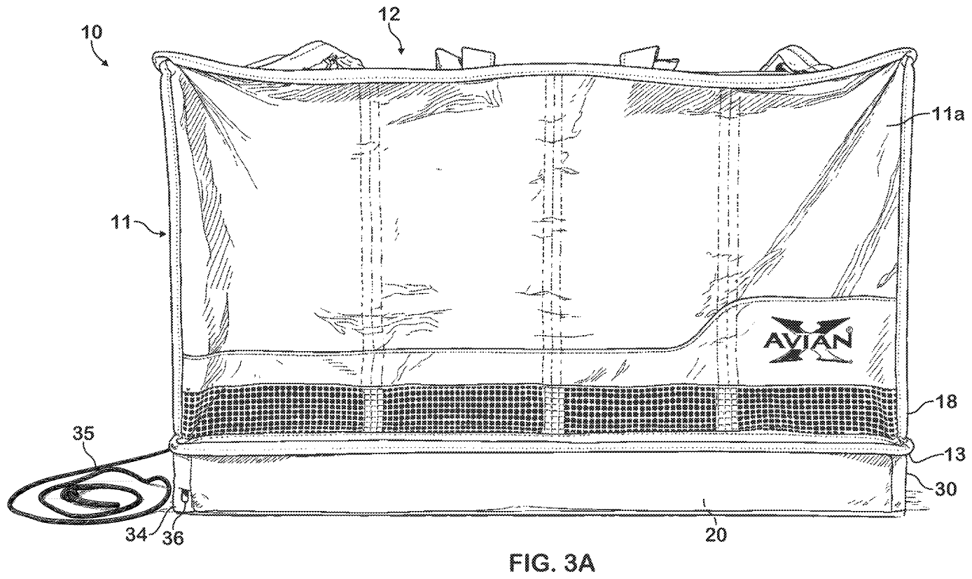

By contrast, FIGS. 2A-2B illustrates side views of another floating decoy bag 10 according to the present disclosure. The bottom 13 of the bag 10 includes a sleeve 30 having a pocket 32 in which the float 20 is disposed. The pocket 32 can have an opening 34 through which the float 20 can be removably inserted. The opening 34 can have a zipper or other closure.

As shown in FIG. 2A, the sleeve 30 can be integral to the bottom 13. As shown in FIG. 2B, the sleeve 30 can be removably affixable to the bottom 13 using fasteners 17, 37, such as hook and loop fastener strips.

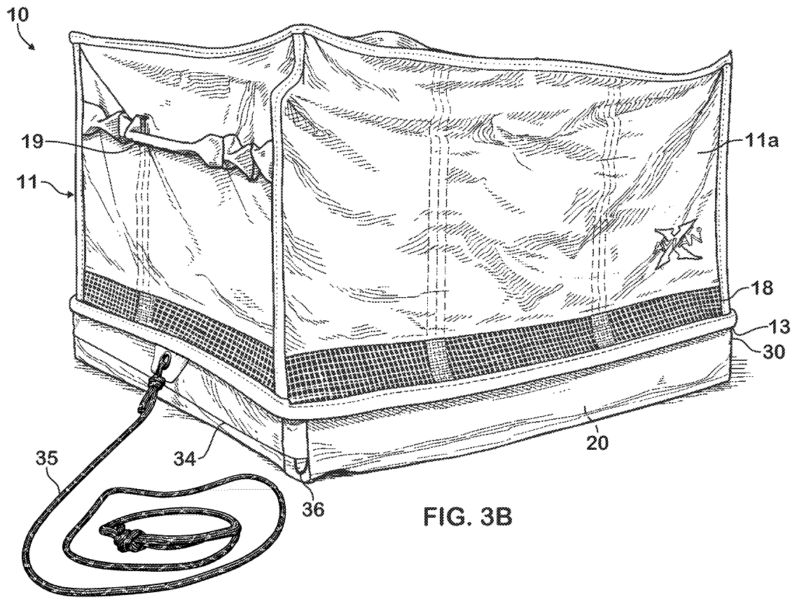

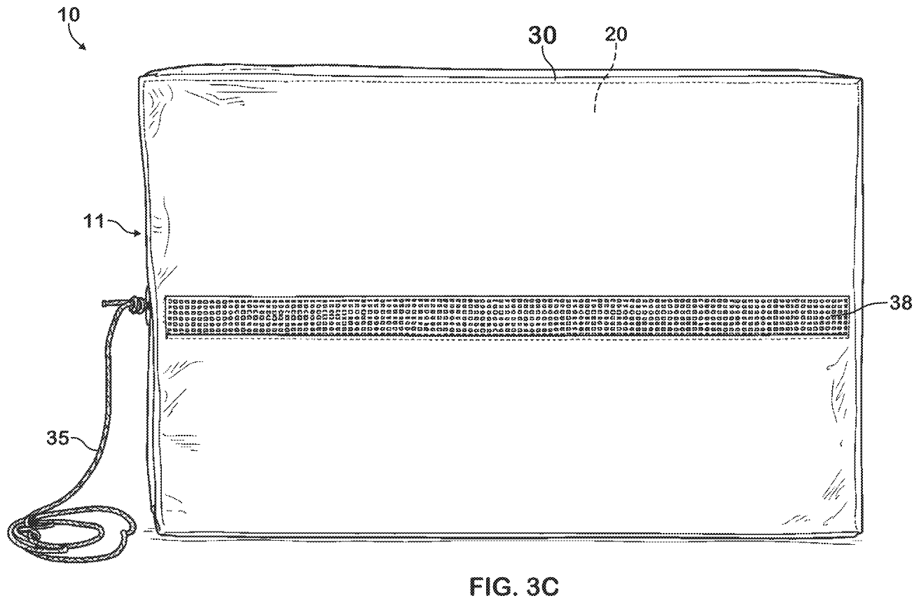

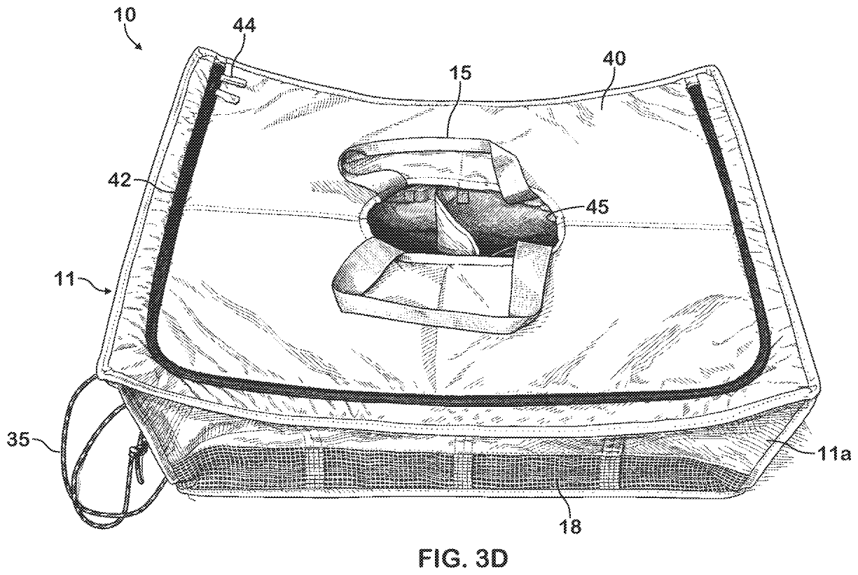

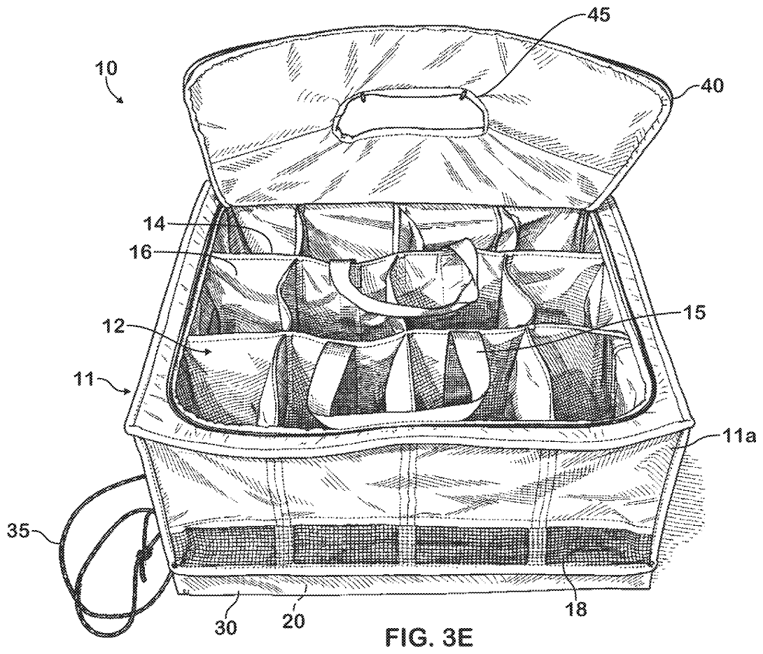

FIGS. 3A, 3B, and 3C illustrate side, perspective, and bottom views of yet another floating decoy bag 10 according to the present disclosure. Meanwhile, FIGS. 3D and 3E illustrate top views of the bag 10 having a flap 40 respectively closed and opened.

Again, the bag 10 includes body 11 forming a sidewall 11a and a bottom 13, which enclose an interior 12 for storage of the waterfowl decoys (not shown). The sidewall 11a encircles the interior 12, making up four sides of the bag 10. The bottom 13 covers the bottom of the interior 12. At least a portion of the sidewall 11a defines a vent 18 exposing the interior 12 outside the bag 10 so any water caught in the interior 12 can escape. The sidewall 11a, the bottom 13, and other portions of the body 11 of the bag 10 can be composed of a suitable material, such as a synthetic fabric. The vent 18 can include a mesh affixed over an opening in the sidewall 11a so that the meshed vent 18 becomes part of the sides of the bag's body. As shown, the vent 18 is preferably defined toward the bottom 13 of the bag 10 so water entering the interior 12 can more fully drain.

As shown, the interior 12 is divided into a plurality of pockets 16 by dividers 14, which provide separate storage of a decoy (not shown) in each pocket 16. A float 20 disposed at the bottom 13 is buoyant and supports the bag 10 on the water surface. In this configuration, the float 20 can be disposed in a pocket (32) of a sleeve 30 integrally or removably attached to the bottom 13 of the bag 10. An opening 34 in the sleeve 30 can allow the float 20 to be removably inserted, and the opening 34 can have a zipper or other closure 36.

As best shown in FIG. 3B, a tow line 35 is attached to the bag 10 and can be affixed toward the bottom 13. The sidewall 11a at the ends of the bag 10 can include a handle 19. Finally, as shown in FIG. 3C, the base of the sleeve 30 can include a vent 38, which would allow any water collected inside the sleeve 30 to escape.

As shown in FIGS. 3D and 3E, the body 11 forms a flap 40 extending from an edge of the sidewall 11a, and the flap 40 can be opened and closed at the top of the bag 10 over the interior 12. A fastener arrangement can be used to keep the flap 40 closed and can be released or undone to allow the flap 40 to be opened. For example, the fastener arrangement can use a zipper arrangement having interlocking teeth 42 positioned along three edges of the flap 40. One or more sliders 44 of the zipper arrangement can be provided to zip and unzip the interlocking teeth 42 along the edges of the flap 40. As will be appreciated, other fastener arrangements can be used to keep the flap 40 closed, such as hook and loop fasteners, stud buttons, snap buttons, ties, and the like.

The dividers 14 in the interior 12 have handles 15 attached thereto, and the flap 40 defines an opening 45 for passage of the handles 15 through the flap 40 when closed. This configuration allows a hunter to carry the bag 10 using the handles 15 when the flap 40 is closed.

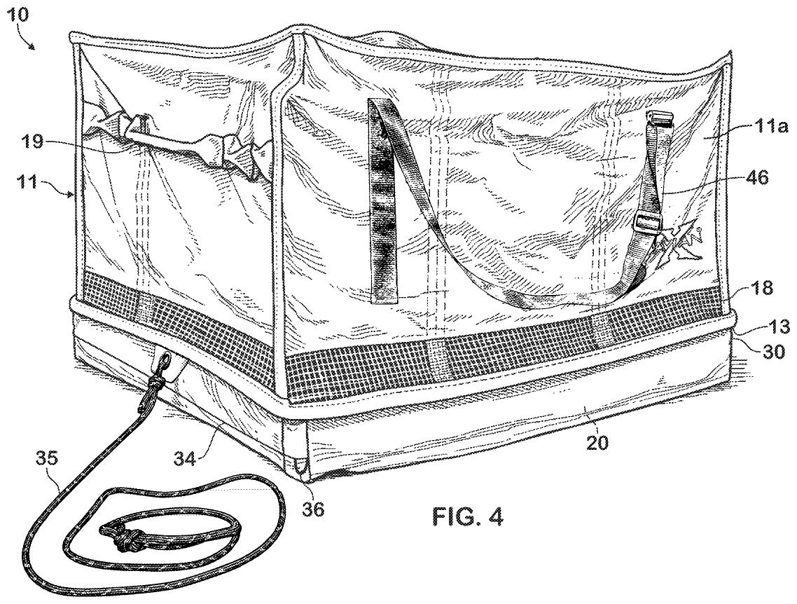

Additional variations are possible for the disclosed floating decoy bag 10. For example, FIG. 4 illustrates the view of the floating decoy bag 10 in FIG. 3B including shoulder straps 46. Opposing sides of the bag's sidewall 11 include the shoulder strap 46 so a hunter can carry the bag 10 on his/her shoulder.

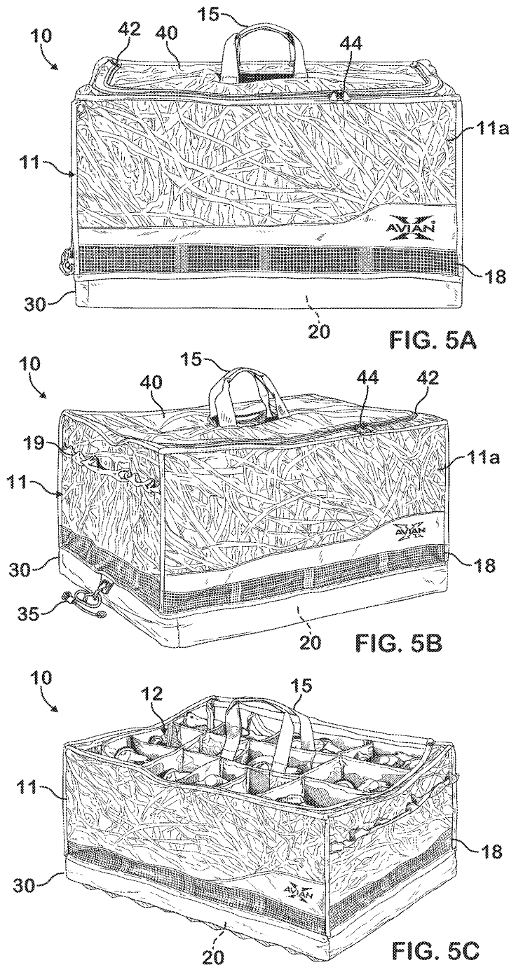

Moreover, FIGS. 5A-5C illustrates various views of another floating decoy bag 10 of the present disclosure. This floating decoy bag 10 can be similar to the others disclosed herein so like reference numerals are used. As shown here, the floating decoy bag 10 can have camouflage or another pattern on the sidewall 11a and the flap 40 of the bag's body 11.

In each of the different arrangements of the floating decoy bag 10 discussed above, the float 20 can include a body (i.e., pad) composed of a closed-cell foam (e.g., closed-cell polyethylene, ethylene vinyl acetate (EVA), or polystyrene). The float 20 can include an inflatable bladder (composed of polyvinyl chloride (PVC), polyamide, thermoplastic polyurethane (TPU), or rubberized fabric), one or more sealed plastic containers (composed of high-density polyethylene (HDPE), polyethylene terephthalate (PET), etc.), or other flotation device. Preferably, the float 20 is positioned evenly on the bottom 13 of the bag 10 to keep the bag 10 stable. Additionally, the float 20 is preferably concealed. To keep a low profile for the bag 10, the float 20 can preferably use a flat pad of closed-cell foam that covers the entire bottom 13 of the bag 10.

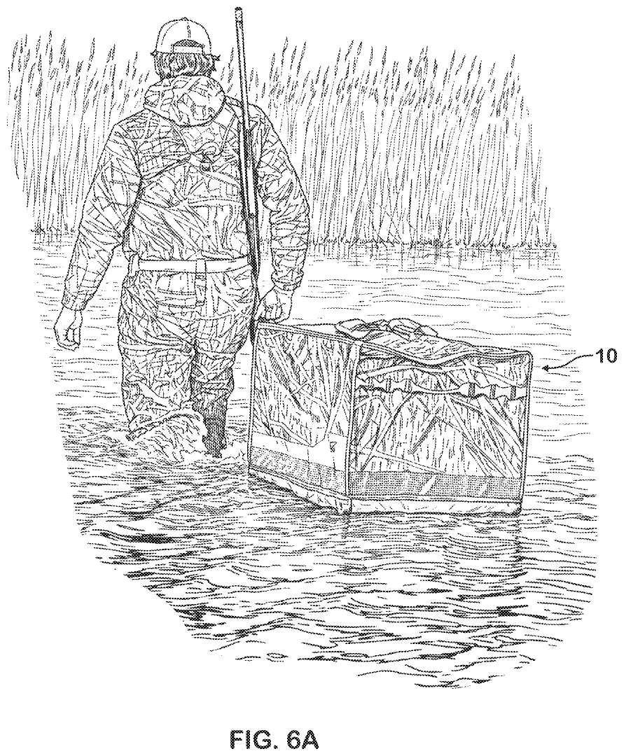

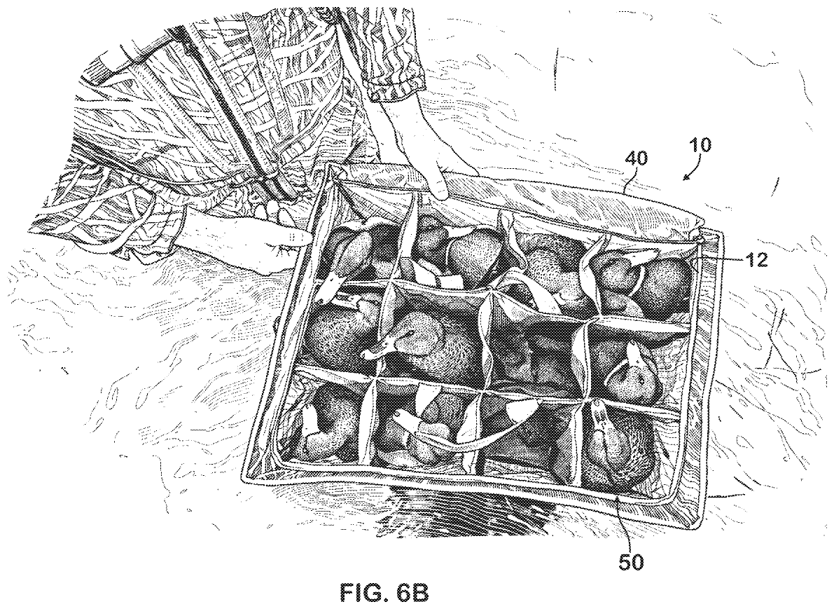

The float 20 elevates the decoy bag 10 on the surface of the water, and the buoyancy of the float 20 is configured to float the bag 10 and the weight of the decoys above the water surface. For example, FIG. 6A illustrates the floating decoy bag 10 being moved along the surface of the water by a hunter, and FIG. 6B illustrates the floating decoy bag 10 on the surface of the water with the flap 40 open to access the decoys 50 in the interior 12.

The size of the float 20 needed for a given implementation depends on the estimated weight of the decoys 50 stored in the bag 10 and is a function of how much water the float 20 displaces to keep the bag 10 and weight buoyant. The tow line 35 allows the hunter to easily pull the decoys 50 and the bag 10 on the water surface as a spread of decoys 50 is laid out or taken up. Once the decoy bag 10 is fully loaded with decoys 50, for example, the hunter can place the bag 10 on the water and tow the bag 10 to the desired hunting location. This simplifies the effort needed to take these heavy bags and decoys to remote areas.

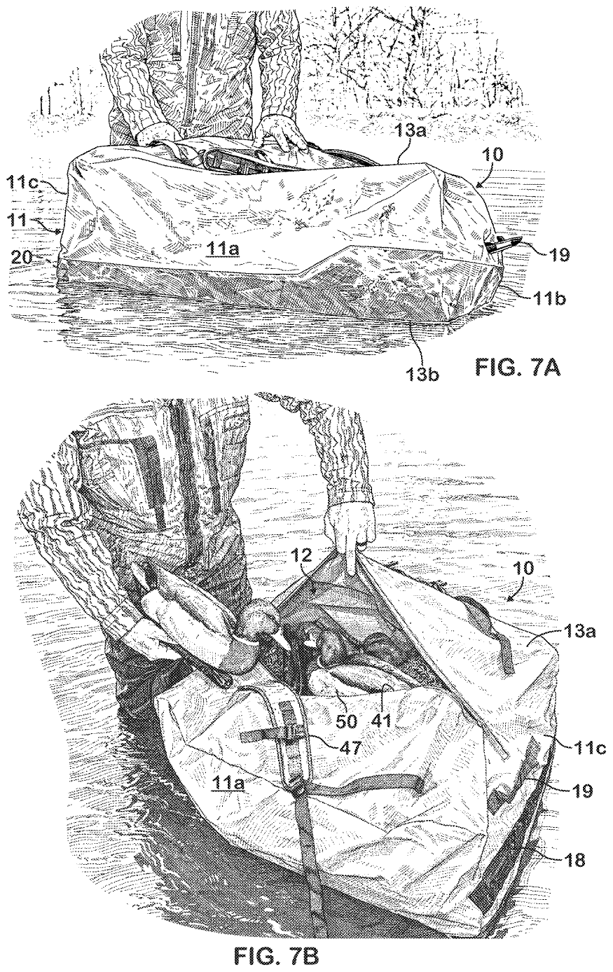

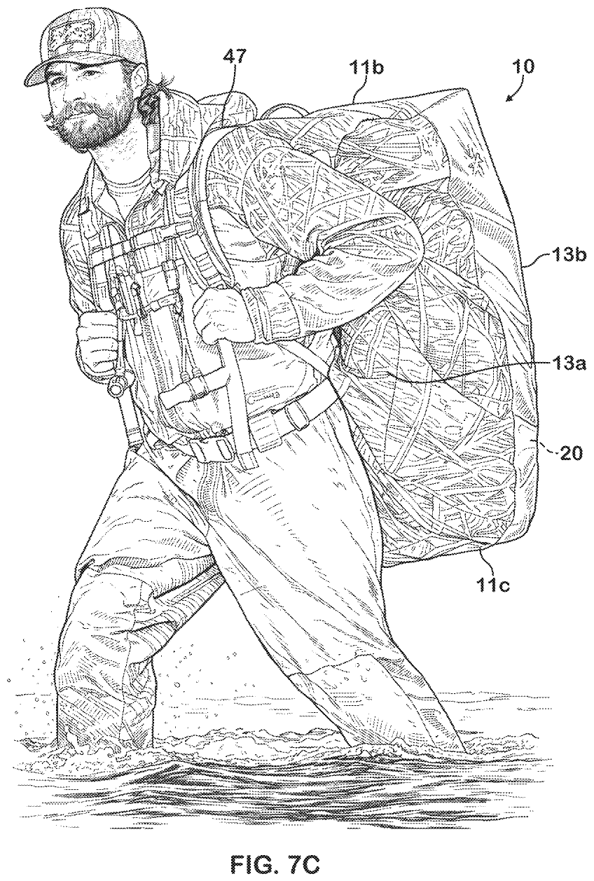

In each of the previous examples, the floating decoy bag 10 has the form of a duffle bag with the sidewall 11a being sturdy or reinforced. The disclosed floating decoy bag 10 can have other forms, such as a tote bag, a backpack, and the like. For example, FIGS. 7A-7B illustrates various views of yet another floating decoy bag 10 of the present disclosure. This bag 10 has the size of a duffle bag and can be carried like a backpack. The bag 10 includes a body 11 forming a sidewall 11a, a top 13a, and a bottom 13b. The sidewall 11a has a top end 11b and a bottom end 11c. These referential terms, such as top, bottom, etc., used here and elsewhere in the disclosure are merely illustrative for the purposes of discussion. The bottom 13b of the bag 10 has the float 20, which can extend along the length of the bottom 13b from the top end 11b to the bottom end 11c. In this way, the bag 10 can float on the water's surface as shown in FIGS. 7A-7B. Meanwhile, the majority of the bag 10 can be above the water, and the top 13a of the bag 10 can be accessible to a hunter.

As shown in FIG. 7A, the top end 11b of the bag 10 can have a handle 19 for lifting and pulling the bag 10. As shown in FIG. 7B, the bottom end 11c of the bag 10 can have a vent 18 so water can drain from the interior 12 of the bag 10 when floating on the water and when lifted upright to be carried.

The sidewall 11a comes together at the top 13a of the bag 10, and an opening 41 defined in the top 13a can be opened and closed by a fastener arrangement, such as a zipper or other closure, to access the interior 12 where decoys 50 can be stored. As shown, the interior 12 may not include dividers or compartments, but it may have separations or the like to at least separate the decoys 50 in the interior 12, especially when the bag 10 is turned upright. The top 13a also includes shoulder straps 47 so the bag 10 can be worn like a backpack by a hunter, as shown in FIG. 7C. First ends of the straps 47 can affix toward the top end 11b, while the second ends of the straps 47 can affix to portion of the sidewall 11a such as at the top 13a. The back 13b of the bag 10 is used as the bottom in the water where the float 20 is located. The back 13b may be stiffer and may rest away from the hunter so wearing the bag 10 as a backpack using the shoulder straps 47 may be easier.

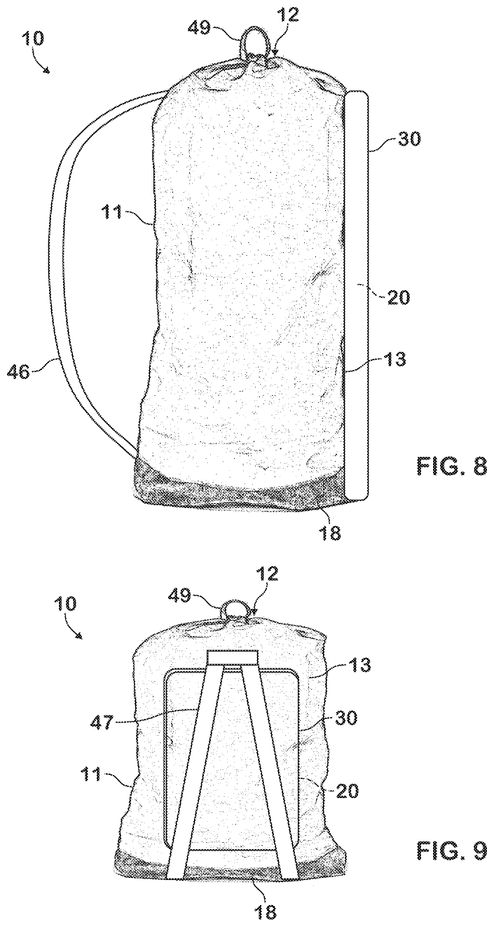

In FIG. 8, an alternative floating decoy bag 10 of the present disclosure has the form of a duffle bag with a body 11 of flexible material. The body 11 has one end that is opened to the interior 12 and can be closed by a pull tie 49, although a flap and other closure may be used. The float 20 can be disposed in a receptacle 30 on a bottom 13 of the bag 10, which extends along a length of the bag's body 11. One or more shoulder straps 46 can be used for carrying the bag 10, and the lower end of the bag 10 can define a vent 18 for draining water from the interior 12.

In FIG. 9, yet another alternative floating decoy bag 10 of the present disclosure has the form of a backpack with a body 11 of flexible material. The body 11 has one end that is opened to the interior 12 and can be closed by a pull tie 49, although a flap and other closure may be used. The float 20 can be disposed in a receptacle 30 on a bottom 13 of the bag 10, which extends along a length of the bag's body 11. Shoulder strap 46 can be used for carrying the bag 10, and the lower end of the bag 10 can define a vent 18 for draining water from the interior 12.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A bag for waterfowl decoys used in water, the bag comprising:
a body at least forming a sidewall and a bottom of the bag and enclosing an interior for storage of the waterfowl decoys, at least a portion of the body defining a vent exposing the interior outside the bag; and
a float disposed on the bag, the float being buoyant and being configured to support the bag on the water surface.

2. The bag of claim 1, wherein the interior is divided into a plurality of pockets by dividers.

3. The bag of claim 2, wherein one of:
the dividers are removable from the interior; and
the dividers are affixed in the interior to at least one of the sidewall and the bottom.

4. The bag of claim 1, wherein the float is disposed at the bottom of the bag.

5. The bag of claim 4, wherein the bottom of the body comprises a sleeve having a pocket in which the float is disposed.

6. The bag of claim 5, wherein one of:
the sleeve is integral to the bottom of the body; and
the sleeve is removably affixable to the bottom.

7. The bag of claim 5, wherein the pocket of the sleeve has an opening through which the float is removably inserted.

8. The bag of claim 1, wherein the body forms a flap being movable between an open position and a closed position over the interior.

9. The bag of claim 8, comprising a fastener arrangement being configured to releasably fasten the flap in the closed position.

10. The bag of claim 9, wherein the interior is divided into a plurality of pockets by dividers, the dividers being affixed in the interior and having handles attached thereto, the flap defining an opening for passage of the handles through the flap in the closed position.

11. The bag of claim 1, wherein the body forms a top of the bag enclosing the interior, the top defining an opening exposed to the interior; and wherein the bag comprises a fastener arrangement disposed on the body and being configured to open and close the opening.

12. The bag of claim 1, wherein the float comprises one of: a closed-cell foam, an inflatable bladder, and a sealed container.

13. A bag for waterfowl decoys used in water, the bag comprising:
a body at least forming a sidewall, a bottom, and a flap of the bag, the body enclosing an interior for storage of the waterfowl decoys, the interior being divided into a plurality of pockets by dividers, the dividers being affixed in the interior and having handles attached thereto, at least a portion of the body defining a vent exposing the interior outside the bag, the flap being movable between an open position and a closed position over the interior, the flap defining an opening for passage of the handles through the flap in the closed position; and
a float disposed on the bag, the float being buoyant and being configured to support the bag on the water surface.

14. The bag of claim 13, comprising a sleeve disposed at the bottom of the bag, the sleeve having a receptacle having the float disposed therein.

15. The bag of claim 14, wherein the sleeve is one of: integral to the bottom, and removably affixable to the bottom.

16. The bag of claim 14, wherein the receptacle of the sleeve has an opening through which the float is removably inserted.

17. The bag of claim 13, wherein at least a portion of the sleeve defines another vent exposing the receptacle outside the bag.

18. The bag of claim 13, comprising a fastener arrangement being configured to releasable fasten the flap in the closed positioned.

19. The bag of claim 13, wherein the float comprises one of: a closed-cell foam, an inflatable bladder, and a sealed container.

20. A bag for waterfowl decoys used in water, the bag comprising:
a body at least forming a sidewall, a bottom, and a top of the bag and enclosing an interior for storage of the waterfowl decoys, the top defining an opening exposed to the interior, at least a portion of the body defining a vent exposing the interior outside the bag;
a fastener arrangement disposed on the body and being configured to open and close the opening in the top of the body; and
a float disposed on the bag, the float being buoyant and being configured to support the bag on the water surface.

21-23. (canceled)
